(19) United States
(12) Patent Application Publication
(10) Pub. No.: US 2011/0194623 A1
(43) Pub. Date: Aug. 11, 2011

(54) Reconfigurable Filter for Cable Frequency Tilt Compensation and MoCA Transmitter Leakage Cancellation

(75) Inventors: Tai-Hong Chih, Irvine, CA (US); Ramon A. Gomez, San Juan Cap, CA (US); Francesco Gatta, Laguna Niguel, CA (US)

(73) Assignee: Broadcom Corporation, Irvine, CA (US)

(21) Appl. No.: 12/770,233

(22) Filed: Apr. 29, 2010

Related U.S. Application Data
(60) Provisional application No. 61/302,798, filed on Feb. 9, 2010.
(60) Provisional application No. 61/302,809, filed on Feb. 9, 2010.
(60) Provisional application No. 61/308,545, filed on Feb. 26, 2010.

(51) Int. Cl. H04B 1/66

(52) U.S. Cl. 375/240.29; 375/E07.001

(57) ABSTRACT

A method comprises determining whether a received signal is a first type or second type. The first type of the received signal is low pass filtered. The second type of the received signal is high pass filtered. In one example, the first type of signal is a MoCA signal and the second type of signal is a cable signal. Also, a system includes a reconfigurable filter, a signal determining device, and a control device. The signal determining device is configured to determine if an input signal is a cable signal or a MoCA signal. The control device is configured to arrange the reconfigurable filter as a high pass filter if the input signal is a cable signal and to arrange the reconfigurable filter as a low pass filter if the input signal is a MoCA signal.

### CROSS REFERENCE TO RELATED APPLICATIONS

This application claims priority under 35 U.S.C. §119(e) to U.S. Provisional Patent Applications 61/302,798, filed Feb. 9, 2010, 61/302,809, filed Feb. 9, 2010 and 61/308,545, filed Feb. 26, 2010, which are all incorporated by reference herein in their entireties.

This application is related to U.S. Ser. No. ______, filed ______ (2875.36400001 and/or 2875.3650001), which is/are incorporated by reference herein in its/their entirety.

### FIELD OF THE INVENTION

The present invention generally relates to reconfigurable filters, for example reconfigurable filters that can be used for cable frequency tilt compensation and MoCA transmitter leakage cancellation.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows a system, according to an embodiment of the present invention.

FIG. 2 shows a single input, multiple output amplifier system, according to an embodiment of the present invention.

FIG. 3 shows a two-tuner and two filter arrangement coupled to the system of FIG. 2, according to an embodiment of the present invention.

FIG. 4 shows a reconfigurable filtering system, according to an embodiment of the present invention.

FIG. 5 shows an implementation of a filter system, which can be used in the system of FIG. 4, according to an embodiment of the present invention.

FIG. 6 shows a schematic diagram of the reconfigurable filtering system of FIG. 4, according to an embodiment of the present invention.

FIGS. 7 and 8 show graphs, according to various embodiments of the present invention.

FIG. 9 is a flow chart depicting a method, according to an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Radio Frequency (RF) amplifiers, including broadband RF amplifiers, are typically designed to have flat gain, noise figure (NF), and linearity over their operating frequency range, as much as practically possible. However, in many applications (e.g., cable television (CATV)), the input signal may not have equal power and density across the entire operating frequency range. Also, broadband multi-channel systems, e.g., cable television (CATV) or terrestrial television, are often transmitted over media (e.g., air, cables, or fibers) with non-flat frequency response. As a result, signal power of individual channels may vary widely across an allocated band, even if the transmitted levels are the same. The power difference over frequency can greatly increase the dynamic range requirement for broadband receivers. As an example, CATV systems can suffer from roll-off at high frequencies. This effect is known as tilt or frequency tilt. With the extension of CATV upper frequency range from 860 MHz to 1 GHz by many operators (to deliver more data services), the amount of tilt seen by CATV users may increase significantly.

When the input signal is amplified by a flat gain amplifier, weaker power components of the resulting amplified signal will have poorer signal-to-noise ratio (SNR) and signal-to-distortion ratio (SDR) than prior to amplification. Further, this degradation in SNR and SDR will continue in subsequent signal processing stages of the overall system.

In some cases, the tilt results in attenuation of the signal so that the power at the receiver is below a threshold amount. In this situation, the tilt is usually compensated for by increasing the power at the transmission and/or receiving end across all channels. However, not all channels may need the increased power. For example, lower frequency signals may need no power increase, such that increasing their power causes too high a power at the receiver.

In some systems, different types of signals can be present, e.g., cable signals, Multimedia over Coax Alliance (MoCA) signals, etc. Thus, each signal can present its own problems. Also, compensation for undesired characteristics of these signals can occur at different parts of a frequency spectrum, which can require both a high and low pass filter for compensation. Thus, in a typical system two or more filters may be needed, for example before, in, or after a tuner or receiver. However, reduction in components of a system can also be desired.

Therefore, what is needed is a system and method allowing for reduced components in a system, while allowing for compensation of multiple types of signals at multiple frequencies.

An embodiment of the present invention provides a method comprising at least the following steps. Determining whether a received signal is a first type or second type. Low pass filtering the first type of the received signal. High pass filtering the second type of the received signal. In one example, the first type of signal is a MoCA signal and the second type of signal is a cable signal.

Another embodiment of the present invention provides a system comprising a reconfigurable filter, a signal determining device, and a control device. The signal determining device determines if an input signal is a cable signal or a MoCA signal. The control device is configured to arrange the reconfigurable filter as a high pass filter if the input signal is a cable signal and to arrange the reconfigurable filter as a low pass filter if the input signal is a MoCA signal.

Further features and advantages of the embodiments, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

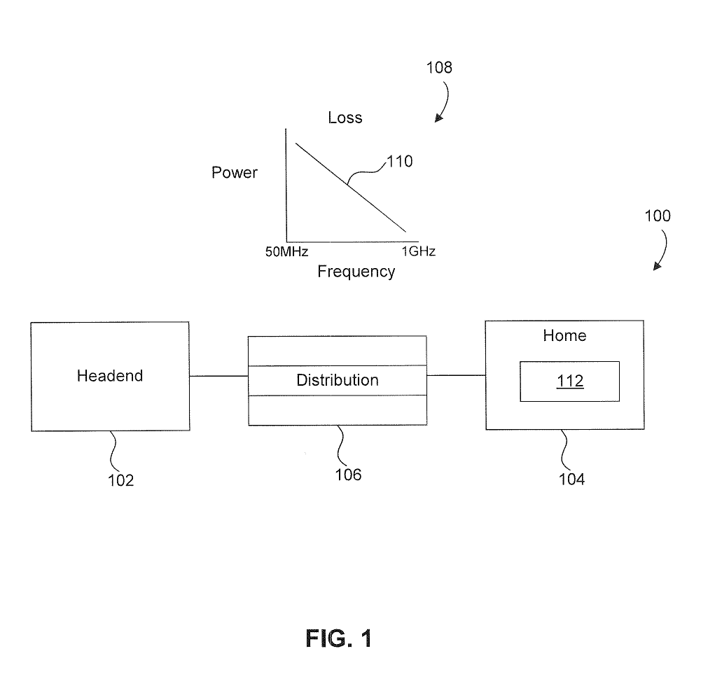

FIG. 1 shows a system 100. For example, system 100 can be a television signal system transmitting cable TV (CATV) signals and/or terrestrial TV signals. System 100 includes a first end 102, e.g., a transmission end, a second end 104, e.g., a receiving end, and a transmission medium 106 coupled therebetween.

In one example, first end 102 can be a headend or a television signal distribution location and second end 104 can be a home or user location. Transmission medium 106 can be a distribution device including, for example, a wired device (e.g., coaxial or fiber optic cables) or a wireless device (e.g., antenna, satellite or cellular). A plurality of signals having different frequencies can be transmitted over distribution device 106 substantially simultaneously as either analog, digital, or both analog and digital signals. The signals may represent a plurality of channels corresponding to the plurality of frequencies. For example, 50 MHz to 1 GHz signals can be transmitted over distribution device 106.

In one example, graph 108 represents an exemplary Power versus Frequency signal loss curve 110. The power loss can be based on attenuation of the signal as it travels over distribution device 106. As can be seen in this example, high frequency signals can exhibit larger power loss during transmission than lower frequency signals. As discussed above, there is a minimum threshold power that should be received at home or user location 104 for the signal to be effective. For example, a home system can have front-end noise. A high frequency signal with a below threshold power may not be effective after interacting with the front-end noise due to distortion. In one example, a tilt or slope of curve 110 can be measured to determine if the value of the frequency band will result in meeting the threshold.

In one example, an amplifying system 112, e.g., a LNA distribution chip, can be located at second end 104. Amplifying system 112 can change the tilt of the signal before forwarding the signal to downstream devices. Changing the tilt of the signal is discussed in more detail below. Herein, signal “tilt” means the gain or loss of the signal over frequency, e.g., a slope of the signal.

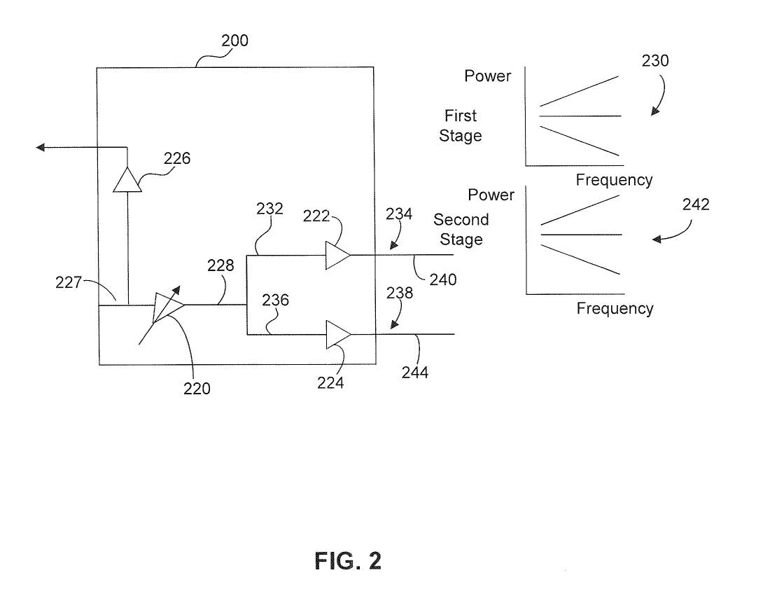

FIG. 2 shows a single input, multiple output amplifier system 200, according to an embodiment of the present invention. For example, system 200 can be implemented as amplifying system 112 in receiving end 104 of system 100 in FIG. 1. In one example, system 200 includes a first amplifier 220, a second amplifier 222, a third amplifier 224, and a fourth amplifier 226. In one example, first amplifier 220 can be considered a first stage amplifier, second and third amplifiers 222 and 224 can be considered second stage amplifiers, and fourth amplifier 226 can be considered a loop through (LT) amplifier. In this configuration, the first and second stage can be considered cascaded. It is to be appreciated more or fewer amplifiers may be found in each amplifier stage or in the LT portion of system 200, based on a desired application.

In one example, first amplifier 220 can be a configurable, adjustable or programmable amplifier. For example, first amplifier 220 can be a gain-tilt amplifier (also known as a tilt amplifier or a frequency tilt amplifier, used interchangeably herein) having a programmable tilt compensation. In one example, a gain-tilt amplifier inverts the frequency response seen by a high frequency signal. In this example, an input signal 227 can be tilted to generate a signal 228 exhibiting a power to frequency curve as shown in graph 230. For example, signal 228 may have a 0 dB (e.g., flat frequency response), +/−5 dB (e.g., tilted frequency response, where +can be tilt up an − can be tilt down), or +/−10 dB (e.g., tilted frequency response), etc. frequency tilt. Thus, amplifier 220 can either increase, decrease, or maintain a tilt of signal 227 when producing signal 228. In one example, positive tilt compensation can mean that the high frequency portion of the signal will be increased relative to the low frequency portion of the signal. Similarly, negative tilt compensation can beam that the low frequency portion of the signal will be decreased relative to the high frequency portion of the signal.

In the example shown, signal 228 can be split to produce two substantially equivalent signals 232 and 236. Signal 232 can travel along path 234 and signal 236 can travel along path 238. In this example, signal 232 can be received by amplifier 222 and signal 236 can be receive by amplifier 224.

Similarly to the function of amplifier 220, second and third amplifiers 222 and 224 can also be implemented as configurable, adjustable, or programmable gain-tilt amplifiers that exhibit a flat or tilted response. For example, a 0 dB, +/−5 dB, or +/−10 dB, etc., tilt can be generated with amplifier 222 and/or amplifier 224. In this example, second amplifier 222 can amplify signal 232 to produce a signal 240 that travels along path 234, and exhibits characteristics of power-frequency curve 230. A tilt or amplitude of signal 232 can be increased, decreased, or maintained by amplifier 222 to produce signal 240. Also, similarly, in this example third amplifier 224 can amplify signal 236 to produce a signal 244 that travels along path 238, and exhibits characteristic of curve 242. For example, a tilt or amplitude of signal 236 can be increased, decreased, or maintained by amplifier 224 to produce signal 244.

In one example, first amplifier 220, second amplifier 222, and third amplifier 224 can function as full spectrum in, full spectrum out amplifiers, such that the only processing of the signal is to correct for any frequency tilt.

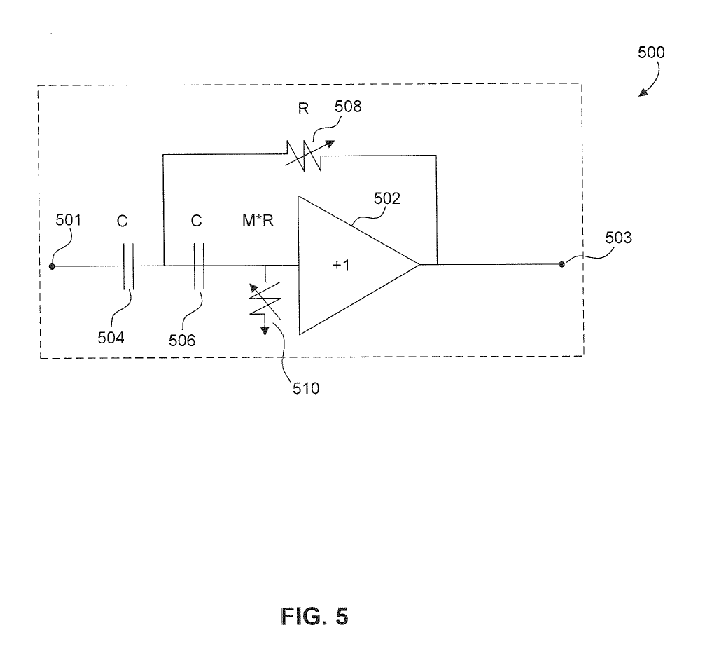

In one example, fourth amplifier 226 can be a loop through (LT) amplifier in a loop through (LT) path. In one example, fourth amplifier 226 is a fixed gain amplifier. In one example, LT amplifier 226 can be used to drive set-top boxes that do not have automatic gain control or TV sets. In another example, LT amplifier 226 can have fixed gain, low noise figure and high linearity to substantially eliminate degradation of the TV sets or set-top box that it is driving. Low and fixed gain substantially eliminates TV overload. In another example, LT amplifier 226 can have many modes, low noise figure or high linearity, and its dynamic range can be optimized for the different terrestrial or cable conditions. An exemplary implementation utilizing the LT path is shown in FIG. 5, discussed below.

In one example, amplifiers 220, 222, 224, and 226 can be amplifiers that exhibit a low noise figure with high linearity, e.g., low noise amplifiers (LNAs).

In one example, amplifiers 220, 222, and 224 can have automatic gain control (AGC) paths. Having automatic gain control paths can assure that subsequent downstream devices along paths 228, 234 and 238 will receive a signal having constant input power.

In one example, amplifier 220 is configurable to have either low noise figure and low linearity or normal noise figure and linearity. For example, terrestrial systems emphasize noise figure, while CATV systems emphasize linearity.

In one example, the second stage gain is controlled using a device (not shown) deter mining an optimal gain based on system wide information gathered regarding signals being processed throughout system 100 and/or system 200 or downstream devices.

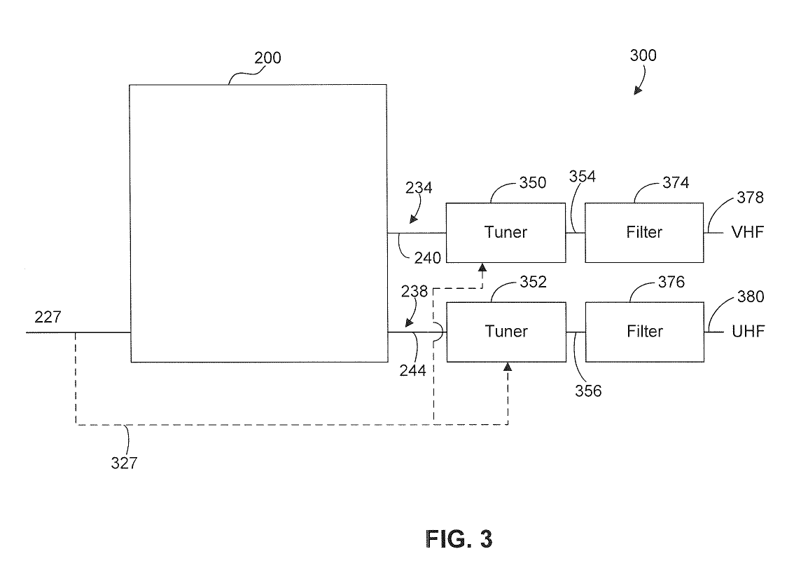

FIG. 3 shows a two-tuner arrangement 300 coupled to system 200 of FIG. 2, according to an embodiment of the present invention. For example, arrangement 300 can include a first tuner Tuner 1 350 and a second tuner Tuner 2 352. It is to be appreciated tuners or receivers are used interchangeably by skilled artisans, although each has a distinct functionality. The embodiments described herein are not limited to tuners, or receivers.

In this example, Tuner 1 350 is coupled along path 234 and Tuner 2 352 is coupled along path 238. In one example, two tuners can be used in order to allow for more complex signal processing of a CATV or terrestrial signal, e.g., to allow for picture-in-picture or other functionality in a cable or set-top box. In this example, Tuner 1 350 can produce a signal 354 along path 234 and Tuner 2 352 can produce a signal 356 along path 238.

It is to be appreciated that, although two paths and tuners are shown, any number of paths and/or tuners can be used based on a desired application, and the system is not limited to two tuners.

In one example, as discussed above, when each of amplifiers 220, 222, and 224 in FIG. 2 (not shown in element 200 in FIG. 3) have automatic gain control, each tuner 350 and 352 can receive a constant input power.

In one example, Tuner 1 350 receives a low frequency channel and Tuner 2 352 receives a high frequency channel. In this arrangement, Tuner 1 350 would benefit from no negative tilt compensation being used, while Tuner 2 352 would benefit from the tilt being asserted on signal 244. In this example, by having tilt in the second stage, the first stage of the amplifier 200 can be used at a higher take-over point (input level), thus maximizing signal to noise ratio, while the high power interferers at low frequency can be removed by the second stage tilt. This can be considered independent tilt compensation both per amplifier stage and within the second amplifier stage.

In an optional arrangement, arrangement 300 further includes a first filter 374 that filters signal 354 along path 234 and a second filter 376 that filters signal 356 along path 238. In one example, this optional arrangement 300 can be considered a band-split arrangement.

In one example, first filter 374 can be any form of filter based on an application, for example a high pass, low pass, or band pass filter, to produce a desired filter signal 378 along path 234. Similarly, second filter 376 can be any form of filter based on an application, for example a high pass, low pass, or band pass filter, to produce a desired filter signal 380 along path 238.

In one example, first filter 374 can be a low pass filter arranged to produce a VHF signal along path 234 and second filter 376 can be a band pass filter arranged to produce a UHF signal along path 238. For example, this arrangement can improve isolation between the two bands and can substantially reduce the tuner dynamic range.

In one example, even after passing through system 200, some of the frequency tilt may remain in a signal traveling along signal paths 234 or 238. For example, based on a specific frequency of the channel, a signal can still have frequency tilt outside of an acceptable tolerance. In another example, Tuner 1 350 and/or Tuner 2 352 may receive signals without the signals being processed within system 200. For example, as shown as a dashed line in FIG. 3, a signal along path 327 may bypass system 200 and be received directly at Tuner 1 350 and/or Tuner 2 352.

Further, different types of signals may exist on paths 234, 238, or 327, for example cable signals, Multimedia over Coax Alliance (MoCa) signals, etc. Each type of signal may need different compensation for different parts of the frequency spectrum. For example, as discussed throughout, cable signals typically have frequency tilt at high frequencies, while MoCa signals typically have interference or other issues at low frequencies. Thus, to produce a most effective signal to be used by Tuner 1 350 or Tuner 2 352, or other components along paths 234 and 238, compensation may need to be performed on signals transmitted along paths 234, 238, and 327. In one example, by compensating for any type of signal, a dynamic range of Tuner 1 350 and/or Tuner 2 352 can be relaxed.

Compensation can be accomplished using a filter before or after the respective tuner to substantially eliminate the high or low frequency signals, as desired for a specific application. For example, for a MoCA signal, compensation is desired for the low frequency signals, while for a cable signal having negative tilt, compensation is desired for the high frequency signal. Also, to reduce a required number of components in a system, it can be desirable to have a reconfigurable filter along signal paths 234 and 238 in order to compensate for any type of signal. Thus, filters 374 and/or 376 can be reconfigurable filters.

In one example (not shown), filters 374 and/or 376 can also be either duplicated before Tuner 1 350 and Tuner 2 352 or moved to be located before Tuner 1 350 and Tuner 2 352.

In one example, if filtering is performed after a Tuner, the Tuner can be used to sense or determine what type of signal is being received and to control a subsequent filter to configure the filter to compensate for the received signal. For example, a tuner can determine a cable signal is received and control a subsequent filter to be a high pass filter to compensate for any negative frequency tilt present in the signal. In another example, a tuner can determine a MoCA signal is received and control a subsequent filter to be a low pass filter.

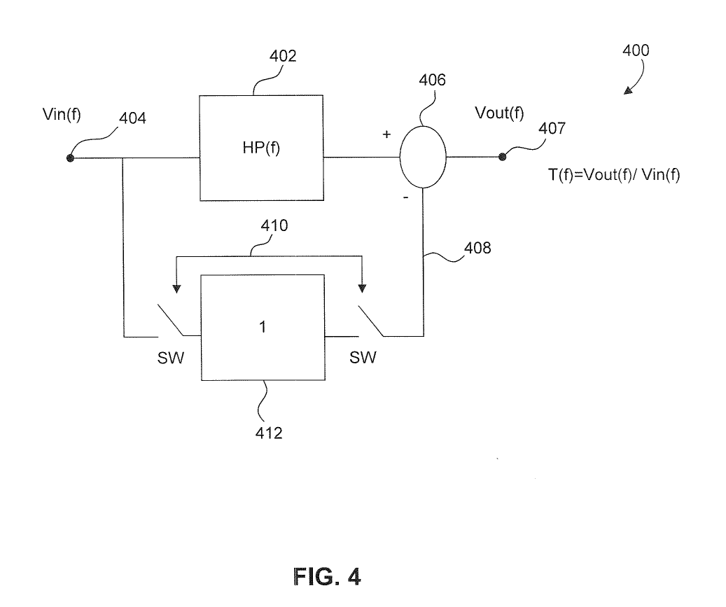

FIG. 4 shows a reconfigurable filtering system 400, according to an embodiment of the present invention. For example, filtering system 400 can be used to implement reconfigurable arrangement for filters 374 and/or 376 discussed above in FIG. 3, or in other portions of system 100. In one example, a reconfigurable High-Pass Filter and Low-Pass Filter is used to compensate frequency tilt (either positive tilt or negative tilt) as a High Pass Filter and to substantially eliminate leakage for Multimedia over Coax Alliance (MoCA) Transmitter's as a Low Pass Filter. Thus, in this cancellation scheme an existing High Pass filter can be reconfigured to produce the Low Pass profile. This arrangement can be used to save area/cost by reducing the total passive components (especially the capacitors) used to implement both High Pass and Low Pass function by half.

In the embodiment shown in FIG. 4, filtering system 400 is shown. In this example, a high pass filter 402 is coupled between an input 404 and a mixer 406, as well as block 412 being coupled between input 404 and mixer 406. Mixer 406 is coupled to an output 407 and a feedfoward loop 408. Feedforward loop 408 includes a switching system 410, having switches 410A and 410B, and block 412. A signal from input 404 splits and travels in parallel through the top path with filter 402 and the feedforward path 408 with block 412. The signal is then mixed at mixer 406, and the mixed signal is output from output 407. In this configuration:

T(f)=Vout(f)/Vin(f)

During a high pass filtering arrangement:

SW=0 (i.e., open)

T(f)=HP(f)

During a low pass filtering arrangement:

SW=1 (i.e., closed)

T(f)=1−HP(f)=LP(f)

In one example, the embodiment of FIG. 4 can be an RF Filter block to implement either HPF or LPF. The RF Filter block can be tunable to about 3 dB bandwidth from about 130 MHz to 500 MHz. The RF Filter has a control bit, SW, to select either the HPF or LPF configuration.

FIG. 5 shows an implementation of a filter system 500, which can be used to implement filter 402 in system 400 of FIG. 4, according to an embodiment of the present invention. Filter system 500 is configured in a Sallen-Key topology to perform high pass filtering. The Sallen-Key topology is a filter topology that can be used to implement second-order active filters. In system 500, a 0-dB gain buffer stage 502 is coupled between an input 501 and an output 503. System 500 also includes first and second capacitive devices 504 and 506 and first and second resistive devices 508 and 510, for example variable resistive devices.

In one example, capacitive devices 504 and 506 are 3 PF capacitors and resistive device 508 and 510 are programmable resistors, e.g., between about 200 ohm˜25 ohm to tune the Filter bandwidth.

A second-order unity-gain high-pass filter, such as filter 500, has the transfer function:

$$H ( s ) = \frac{{s}^{2}}{{s}^{2} + {\underbrace{2 π ( \frac{{f}_{c}}{Q} )}}_{2 {ζω}_{c} = \frac{{ω}_{c}}{Q}} s + {\underbrace{{( 2 π {f}_{c} )}^{2}}}_{{ω}_{c}^{2}}} ,$$

where s=jω=(\sqrt{−1})2πf and f is a frequency of a pure sine wave input

where the cutoff frequency f and Q factor Q (i.e., damping ratio ζ). This transfer function is implemented by the equations

$${f}_{c} = \frac{1}{2 π \sqrt{{R}_{1} {R}_{2} {C}_{1} {C}_{2}}}$$

$$and$$

$$\frac{1}{2 ζ} = Q = \frac{\sqrt{{R}_{1} {R}_{2} {C}_{1} {C}_{2}}}{{R}_{1} ( {C}_{1} + {C}_{2} )} . \\ So$$

$$2 ζ {f}_{c} = \frac{{f}_{c}}{Q} = \frac{{C}_{1} + {C}_{2}}{2 π {R}_{2} {C}_{1} {C}_{2}} .$$

In one example M=4 for a HPF and tuning is performed using R.

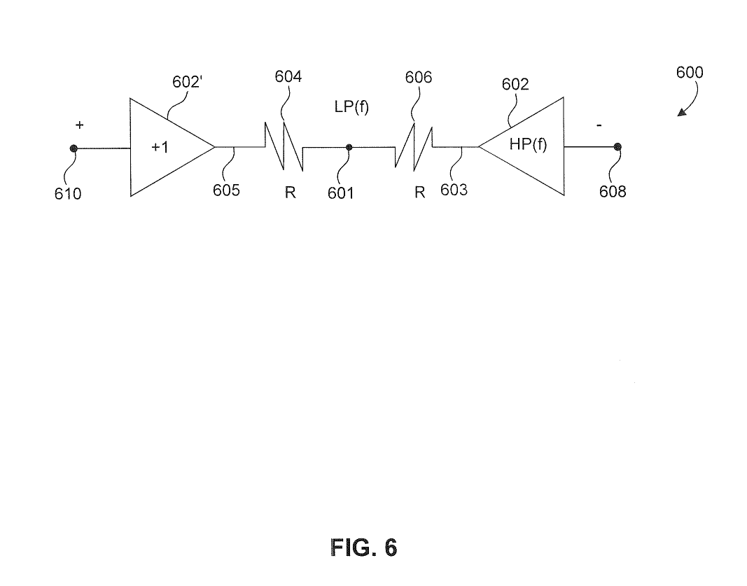

FIG. 6 shows a schematic diagram 600 of reconfigurable filtering system 400 of FIG. 4, according to an embodiment of the present invention. Filtering system 600 can be used to produce a Low pass filter, such that a signal passing through output node 601 is low pass filtered. The LPF is implemented using the cancellation technique. The 0-dB gain buffer stage 602 is copied as 602′ (“+1 stage”) to buffer the “All-Pass” signal. The summing resistors 604 and 606 are added to sum signals at an output 603 of the HPF 602 and an output 605 of “+1 stage” 602′. Input signals at nodes 608 and 610 are differential (0 and 180 degree), and these are applied out of phase signals at the input 608 of HPF 602 and input 610 of the “+1 stage” 602′ to obtain a subtraction. Therefore, the LPF profile is achieved because the signals from the HPF path at node 603 are “subtracted” (or cancelled) from the signals at node 605 of the “+1 stage” 602 all-pass path.

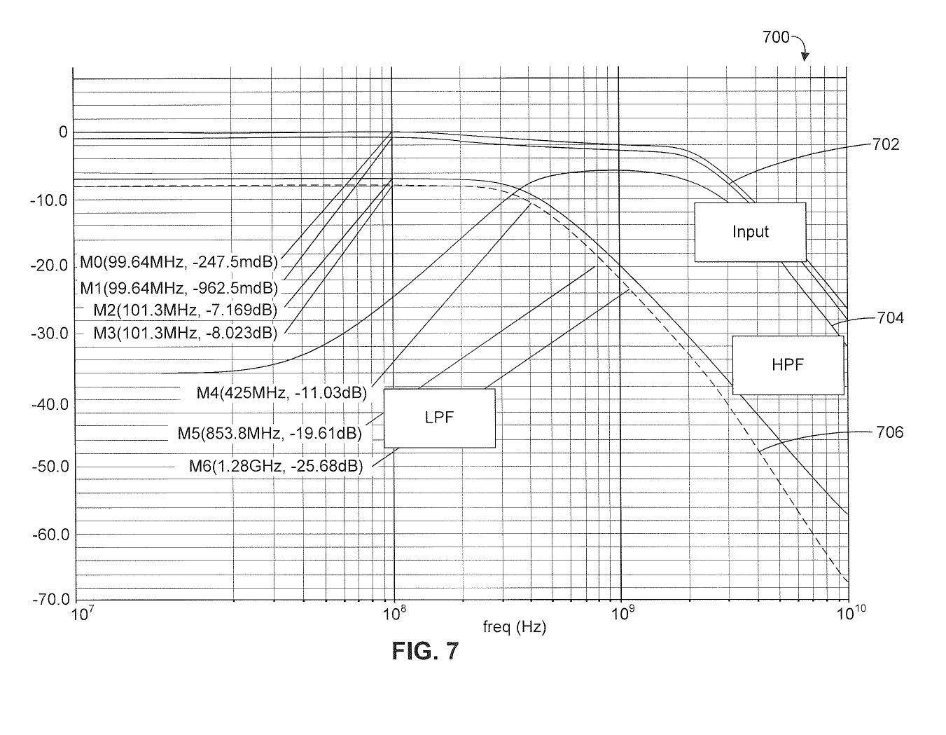

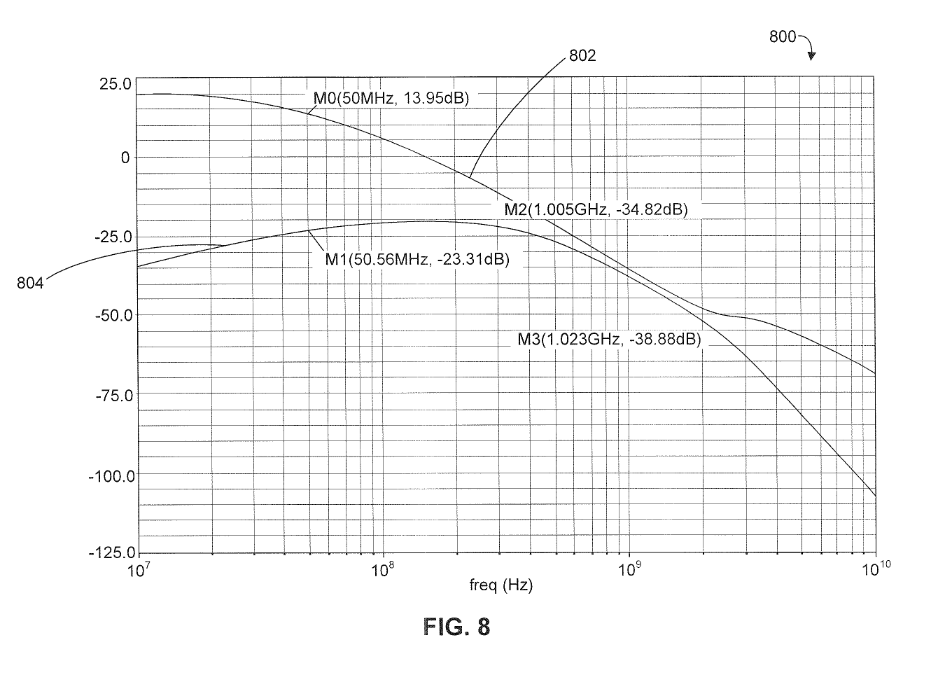

FIGS. 7 and 8 show graphs 700 and 800 for signals input and output from a HPF or LPF, according to various embodiments of the present invention. Exemplary parameters of the graphs 700 and 800 are shown in FIGS. 7 and 8, but should not be seen as limiting in any way.

Graph 700 includes an input signal 702, which has finite bandwidth due to front-end matching network. Outputs results are superimposed as HPF output 704 (e.g., if SW=0) or LPF output 706 (e.g., SW=1).

Graph 800 shows that when a negative tilt is applied, line 802, the High-Pass Filter can compensate for the negative tilt by reducing the low-frequency signal power more than 35 dB as shown in line 804.

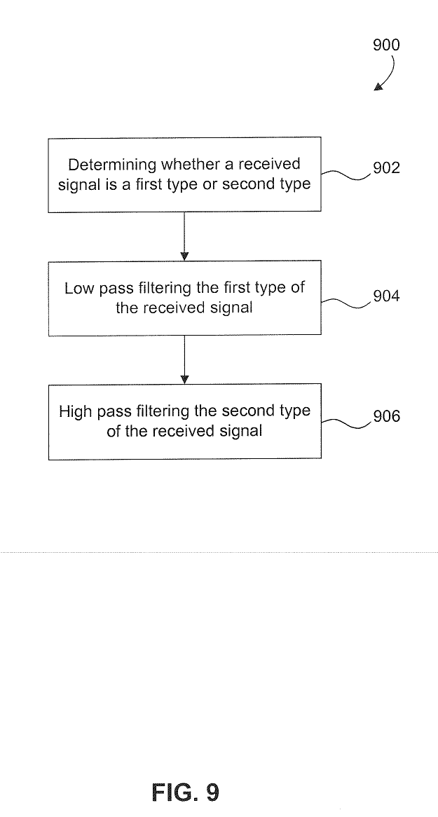

FIG. 9 is a flow chart depicting a method 900, according to an embodiment of the present invention. For example, method 900 can be implemented by one or more of the systems discussed above in FIGS. 1-6. At step 902, a determination is made whether a received signal is a first type or second type. For example, a cable or MoCA signal. At step 904, the first type of signal, e.g., a MoCA signal, is low pass filtered. At step 906, the second type of signal, e.g., a cable signal with frequency tilt, is high pass filtered.

It is to be appreciated that the Detailed Description section, and not the Abstract section, is intended to be used to interpret the claims. The Abstract section may set forth one or more, but not all, exemplary embodiments of the present invention as contemplated by the inventor(s), and thus, are not intended to limit the present invention and the appended claims in any way. The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A method comprising:
determining whether a received signal is a first type or second type;
low pass filtering the first type of the received signal; and
high pass filtering the second type of the received signal.

2. The method of claim 1, further comprising:
using a Multimedia over Coax Alliance (MoCA) signal as the first type; and
using a cable signal as the second type.

3. The method of claim 2, further comprising:
using the low pass filtering to substantially eliminate MoCA transmitter leakage if the first type of signal is determined; and
using the high pass filtering to compensate for any frequency tilt if the second type of signal is determined.

4. The method of claim 1, further comprising:
using a high pass filter in a first configuration to perform the high pass filtering; and
using the high pass filter in a second configuration to perform the low pass filtering.

5. The method of claim 4, further comprising:
opening a switching device in a feedforward loop of a filter system to implement the high pass filtering; and
closing the switching device in the feedforward loop of the filter system to implement the low pass filtering.

6. The method of claim 4, further comprising:
using a Sallen-Key topology in a first configuration to implement the high pass filtering; and
using the Sallen-Key topology in a second configuration to implement the low pass filtering.

7. The method of claim 6, further comprising using a cancellation technique to implement the low pass filtering.

8. A system comprising:
a reconfigurable filter;
a signal determining device configured to determine if an input signal is a cable signal or a MoCA signal; and
a control device configured to arrange the reconfigurable filter as a high pass filter if the input signal is a cable signal and to arrange the reconfigurable filter as a low pass filter if the input signal is a MoCA signal.

9. The system of claim 8, wherein the reconfigurable filter comprises:
a high pass filter;
a mixer;
a switching device; and
a feedforward loop.

10. The system of claim 8, wherein the reconfigurable filter is a Sallen-Key topology filter.
